(19) United States
(12) Patent Application Publication
(10) Pub. No.: US 2017/0359458 A1
(43) Pub. Date: Dec. 14, 2017

(54) SYSTEMS AND METHODS FOR ENHANCING COMMUNICATION DEVICE PERFORMANCE DURING INTERACTION WITH A VOICE RESPONSE SYSTEM

(71) Applicant: Michael ROTHSCHILD, Ramot Hashavim (IL)

(72) Inventor: Michael ROTHSCHILD, Ramot Hashavim (IL)

(21) Appl. No.: 15/540,319

(22) PCT Filed: Feb. 10, 2015
(86) PCT No.: PCT/IB2015/051001

§ 371 Date: Jun. 28, 2017

(51) Int. Cl. H04M 1/725; H04M 3/493; G06F 9/44; H04M 1/22

(52) U.S. Cl. CPC H04M 1/72519; H04M 1/22; H04M 3/493; G06F 9/4443

(57) ABSTRACT

Described herein are ways to enhance communication device performance during the device's interaction with a voice response system. Embodiments of the communication device, such as a mobile telephone with a touch screen, do not have the conventional problems of the touch screens darkening when wanting illuminated screens and requiring a caller to endure undesired audio output while on hold for extended lengths of time, as non-limiting example problems. The invention may also be embodied as a voice response system, a method of its operation, a method of operating a telephone having a touch screen, and a non-transitory machine readable storage medium containing instructions that when executed cause the performance of such methods.

### BACKGROUND

Advances in technology and options for communicating by telephone have made executing calls much more convenient in many respects. For example, a user can preset a single button to speed dial a series of individual numbers, which frees the user from the repetitive task of frequently redialing in full a specific telephone number each time he/she wants to conduct a call with the party associated with the number. As another example of more convenient telephone communication, a user may select a “redial” option to redial the last dialed series of numbers, which also saves the user from repetitively redialing the entire series of numbers.

While the advances in technology have increased the convenience of executing calls in some respects, it has also decreased the convenience in other respects. For example, to conserve battery power of a mobile telephone, many telephones that use a touch screen as an input/output device are programmed to darken the screen automatically when the user is unlikely to need it. A typical scenario for this feature occurs when a user holds the telephone to his/her ear, in which case there is typically no apparent need to illuminate the display. That is, the user is unlikely to simultaneously hold a telephone to his/her ear while also viewing the display and/or entering input. This automatic darkening to conserve battery power is a convenience.

There are scenarios though that a user, when listening to the telephone's audio output, will want to enter input quickly. This could happen if he/she wants to select a “hang-up” option in order to end the call before the applicable system begins recording as a message all sounds that the telephone's microphone receives, including sounds that the user did not want recorded. Another scenario involves a time-constrained (or impatient) user who wants to enter input as soon as possible. Although many conventional telephones that are programmed to darken their displays automatically when users hold the telephones to their ears, are also programmed to illuminate their displays automatically shortly after the users move their telephones away from their ears, the delay resulting from the time elapsed before the display illuminates becomes an annoyance for some users.

Another conventional advance in technology is the automated interactive voice response system (VRS), which receives calls, plays recorded greetings and/or announcements, and instructs the callers how to indicate the service desired or the personal information required. For example, a caller may want to call a bank to check his/her account balance or recent deposits and withdrawals, in which case, the user may need to enter personal identifying information and also to indicate the information desired. Use of a VRS reduces the demand on human resources and makes services available throughout the day and night and also on weekends and holidays.

VRSs, also interchangeably and commonly referred to as Interactive Voice Response (IVR) systems, are commonly used by today's companies and organizations. IVR systems allow for automatic handling of many user requests without the costlier involvement of human respondents. From a user's perspective, interaction with different IVRs is often similar because of the standardization of menu choices and the repeated request for the same information. For example, many IVRs authenticate a user by asking for the user's personal identification number (PIN), mother's maiden name, and/or personal data (e.g., social security number or date of birth). The user may have to endure lengthy comments/instructions and multi-level menus before being able to perform the action that the user wants to perform. Further, the user may not have information requested by the IVR system readily available. The user may also have to repeat information (e.g., difficult to pronounce names or other information) one or more times, and may have to repeat the process numerous times if, for example, the user chooses an incorrect menu choice which leads the user to an undesired part of the IVR system decision tree.

Accordingly, this advance in technology causes inconveniences for users in many implementations. A caller may resent having to listen to a long list of menu options before hearing the particular option that interests him/her. One typical annoying experience is enduring the recitation of a long list of irrelevant options in order to just reach a human support provider only to finally receive the announcement that such particular service is not available at that time.

Also, often callers interested in engaging in conversations with human support providers are required to wait—during the execution of the calls—for an attendant to be available. Typically, the callers, already resenting the time spent waiting, are further required to listen to music, broadcasted programming, or pre-recorded messages that does not interest the caller. However, the callers cannot completely ignore their telephone output, because they do not know when an attendant will become available. Such is further annoying to busy callers who would prefer to address other tasks while waiting for the attendant to become available.

Thus, although the advances in technology have increased efficiency and convenience and have lowered costs in many respects, they have also created inconveniences in other respects. There is therefore a need to address these inconveniences that have developed as a result of the advances in technology.

### SUMMARY

Embodiments of the invention address the problems described above, such as touch screens darkened when wanting illuminated screens and needing to endure undesired audio output while on hold for extended lengths of time. The invention may be embodied as a system, a method, or a storage medium. For specifically:

The invention may be embodied as a voice response system having an input/output module, a processor, and storage. The input/output module is operative to transfer communications to and from a telephone operated by a caller. The processor is operatively connected to the input/output module to receive input from the telephone and to send output to the telephone. The storage containing instructions that, when executed, cause the processor to: receive an indication from the telephone that the caller has initiated a call; and send an instruction to the telephone to illuminate the telephone's touch screen.

The invention may also be embodied as a voice response system having an input/output module, a processor, and storage such that the input/output module is operative to transfer communications to and from a telephone operated by a caller; the processor is operatively connected to the input/output module to receive input from the telephone and to send output to the telephone; and the storage contains instructions that, when executed, cause the processor to: send an instruction to the telephone to notify the caller that the call will be placed on hold; send audible content to the telephone while the call is on hold; cease sending the audio content in response to an instruction from the telephone to cease the sending; and send a notification to the telephone when the call is no longer on hold.

The invention may further be embodied as telephone having a touch screen, an input/output module, a processor, and storage. The input/output module is operative to transfer communications to and from a voice response system. The processor is operatively connected to the input/output module to receive input from the voice response system and to send output to the voice response system. The storage contains instructions that, when executed, cause the processor to: receive an instruction from the voice response system to illuminate the touch screen; and illuminate the touch screen in response to the instruction.

The invention may additionally be embodied as a telephone having: a touch screen; an input/output module operative to transfer communications to and from a voice response system; a processor operatively connected to the input/output module to receive input from the voice response system and to send output to the voice response system; and storage containing instructions that, when executed, cause the processor to: illuminate the touch screen in response to an instruction from the voice response system; receive an instruction from the voice response system to notify the caller that the call will be placed on hold; play audio content that the voice response system sends while the call is on hold; and cease playing audio content.

The invention may also be embodied as a telephone having: a touch screen; an input/output module operative to transfer communications to and from a voice response system; a processor operatively connected to the input/output module to receive input from the voice response system and to send output to the voice response system; and storage containing instructions that, when executed, cause the processor to: receive one or more requests from the voice response system for a caller to select options from one or more lists of pre-determined options; send to the voice response system an indication of each option the user selects; and record the selected options; wherein the recorded selections are available for retrieval and for sending to the voice response system during future calls.

The invention may be embodied as a method of operating a voice response system to communicate with a caller using a telephone having a touch screen. The method includes: receiving an indication from the telephone that the caller has initiated a call; and sending an instruction to the telephone to illuminate the touch screen.

The invention may also be embodied as a method of operating a voice response system to communicate with a caller using a telephone, the method comprising: sending an instruction to the telephone to notify the caller that the call will be placed on hold; sending audible content to the telephone while the call is on hold; ceasing sending the audio content in response to an instruction from the telephone to cease the sending; and sending a notification to the telephone when the call is no longer on hold, the notification indicating that the call is no longer on hold.

The invention may additionally be embodied as a method of operating a telephone having a touch screen to communicate with a voice response system, the method including: receiving an instruction from the voice response system to illuminate the touch screen; and illuminating the touch screen in response to the instruction.

The invention may further be embodied as a method of operating a telephone having a touch screen to communicate with a voice response system. The method includes: illuminating the touch screen in response to an instruction from the voice response system; receiving an instruction from the voice response system to notify the caller that the call will be placed on hold; playing audio content that the voice response system sends while the call is on hold; and ceasing playing audio content.

The invention may additionally be embodied as a method of operating a telephone having a touch screen to communicate with a voice response system, the method including: receiving one or more requests from the voice response system for a caller operating the telephone to select options from one or more lists of pre-determined options; sending to the voice response system an indication of each option the user selects; and recording the selected options. The recorded selections are available for retrieval and for sending to the voice response system during future calls.

The invention may be embodied as a non-transitory machine readable storage medium containing instructions associated with operating a telephone having a touch screen in communication with a voice response system. The instructions when executed cause the following: receiving an instruction from the voice response system to illuminate the touch screen; and illuminating the touch screen in response to the instruction.

The invention may also be embodied as a non-transitory machine readable storage medium containing instructions associated with operating a telephone having a touch screen in communication with a voice response system, the instructions when executed causing the following: illuminating the touch screen in response to an instruction from the voice response system; receiving an instruction from the voice response system to notify the caller that the call will be placed on hold; playing audio content that the voice response system sends while the call is on hold; and ceasing playing audio content.

The invention may further be embodied as a non-transitory machine readable storage medium containing instructions associated with operating a telephone having a touch screen in communication with a voice response system, the instructions when executed causing the following: receiving one or more requests from the voice response system for a caller operating the telephone to select options from one or more lists of pre-determined options; sending to the voice response system an indication of each option the user selects; and recording the selected options; wherein the recorded selections are available for retrieval and for sending to the voice response system during future calls.

The invention may also be embodied as a telephone for a user calling a party that uses a voice response system, the telephone including: a touch screen; an input/output module operative to transfer communications to and from a party and a voice response system; a processor operatively connected to the input/output module to receive input from the party and the voice response system and to send output to the party and the voice response system; and storage containing instructions. The instructions, when executed, cause the processor to configure the telephone before a user calls the party by: prompting the user for a personalized message to repeatedly send to: (1) the voice response system while the user is on hold and (2) the party at the conclusion of the hold state; and prompting the user for a code that the called party is to send to indicate the end of the hold state.

The invention may further be embodied as a telephone for a user calling a party that uses a voice response system, the telephone including: a touch screen; an input/output module operative to transfer communications to and from a party and a voice response system; a processor operatively connected to the input/output module to receive input from the party and the voice response system and to send output to the voice response system; and storage containing instructions. The instructions, when executed, cause the processor to configure the telephone before a user calls the party by: prompting the user for a value to repeatedly send to the voice response system, the value indicating that the user wishes to remain on hold; prompting the user for a message to repeatedly send to: (1) the voice response system while the user is on hold and (2) the party at the conclusion of the hold state; and prompting the user for a code that the called party is to send to indicate the end of the hold state.

The invention may also be embodied as a telephone for a user calling a party that uses a voice response system, the telephone including: a touch screen; an input/output module operative to transfer communications to and from a party and a voice response system; a processor operatively connected to the input/output module to receive input from the party and the voice response system and to send output to the party and the voice response system; and storage containing instructions that, when executed, cause the processor to configure the telephone, after the voice response system places the user on hold, by displaying a button that when pressed prompts the user for: a message to repeatedly send to: (1) the voice response system while the user is on hold and (2) the party at the conclusion of the hold state; and prompting the user for a code that the called party is to send to indicate the end of the hold state.

The invention may additionally be embodied as a telephone for a user calling a party that uses a voice response system, the telephone having: a touch screen; an input/output module operative to transfer communications to and from a party and a voice response system; a processor operatively connected to the input/output module to receive input from the party and the voice response system and to send output to the party and the voice response system; and storage containing instructions that, when executed, cause the processor to configure the telephone: to prompt the user, before calling the party, for a message to repeatedly send to: (1) the voice response system while the user is on hold and to the party at the conclusion of the hold state, and (2) for a value that the party must press to unmute the telephone; and to prompt the user, after the voice response system places the user on hold, for the value that the user must send to indicate that he/she wishes to remain on hold is set during the call.

Embodiments of the present invention are described in detail below with reference to the accompanying drawings, which are briefly described as follows:

### BRIEF DESCRIPTION OF THE DRAWINGS

FIG. 1 illustrates an exemplary architecture of a computing device in communication a VRS system in accordance with an embodiment of the present invention.

FIG. 2 illustrates exemplary functional modules of a system in accordance with an embodiment of the present invention.

FIG. 3 illustrates additional exemplary functional modules of a system in accordance with an embodiment of the present invention.

FIG. 4 illustrates an exemplary method for implementing instructions received from VRS in accordance with an embodiment of the present invention.

FIG. 5 illustrates an exemplary method for implementing instructions received from communication device in accordance with an embodiment of the present invention.

FIG. 6 illustrates an exemplary method for recording user selections at communication device in accordance with an embodiment of the present invention.

### DETAILED DESCRIPTION

Embodiments are now discussed in more detail referring to the accompanying drawings. In the drawings, like and/or corresponding elements are referred to by like reference numbers.

Various embodiments are disclosed herein; however, it is to be understood that the disclosed embodiments are merely illustrative of the invention that can be embodied in various forms. In addition, each of the examples given in connection with the various embodiments is intended to be illustrative and not restrictive. Further, the figures are not necessarily to scale, and some features may be exaggerated to show details of particular components. Therefore, specific structural and functional details disclosed herein are not to be interpreted as limiting but merely as a representative basis for teaching one skilled in the art of the invention.

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM®, ColdFire®, GPU, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments. Although each embodiment represents a single combination of inventive elements, the embodiments herein are considered to include all possible combinations of the disclosed elements.

The invention summarized above and defined by the claims below will be better understood by referring to the present detailed description of embodiments of the invention. This description is not intended to limit the scope of claims but instead to provide examples of the invention.

In general, regarding embodiments of the present disclosure, the invention relates to communication mechanisms between a VRS and a communication device, the communication device also interchangeably referred to as a phone, mobile phone, computing device, or device hereinafter, where continuous or intermitted or periodic signals are sent from the VRS to the device depicting the current state of the VRS. These signals may be utilized by the device and/or its software/hardware/firmware to improve the functioning, performance, and behavior of the device, while optimizing the capabilities of the device using the software/hardware/firmware already present on the device and providing better service to the user relying on information sent by the VRS. Therefore, the system provides more intelligent architecture for efficient communication and user-friendly utilization of phone resources in the process. The VRS, in context of the present disclosure, may include any automated call handling service. One or more functional modules or software/hardware/firmware for implementation of the proposed system may also be configured independently and/or outside of the VRS and instruct the VRS to perform in a particular manner.

A voice response system (VRS) may be regarded as an automated system, generally in use at offices as a replacement for a receptionist, where an automated machine voice directs the caller to a particular department/person. VRSs are also extensively used at service provider customer care offices, such as customer care of mobile network companies, banks, and manufacturing companies. VRSs are an extremely convenient option in such cases as numerous services are offered and the volume of those subscribing to certain services, such as mobile networks, is very large. In view of phenomena discussed in the background section, embodiments of the present invention further optimize the communication process using a VRS. It must be appreciated that no limitations will be drawn with relation to the organization type, field of business or trade, or type of personal use for which a VRS is being used.

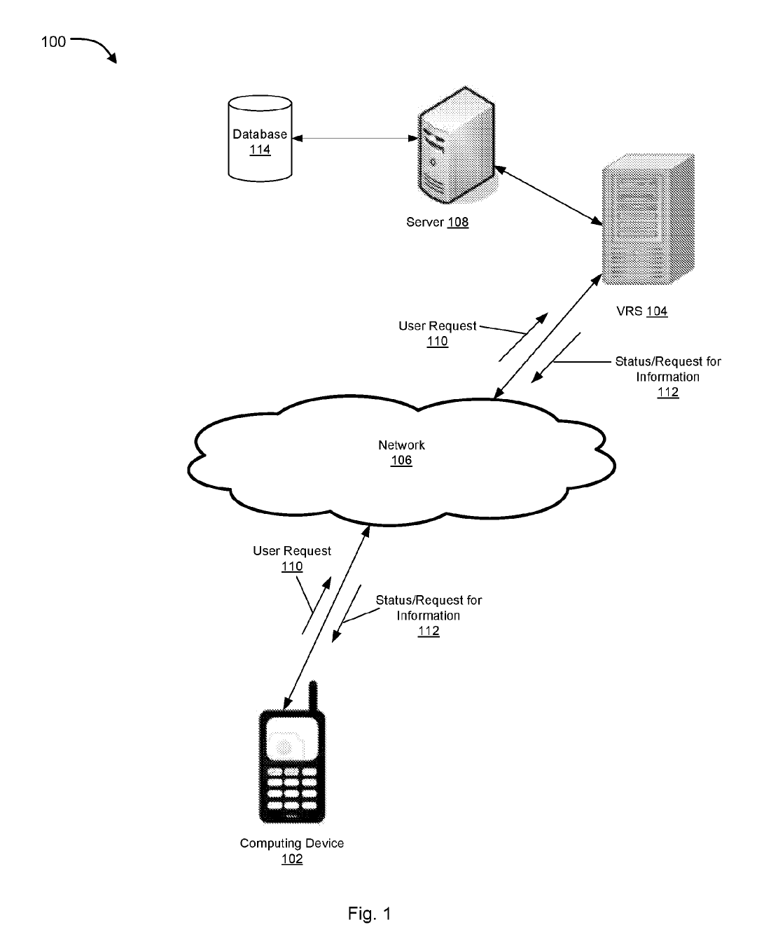

FIG. 1 illustrates exemplary architecture 100 of a computing device 102 in communication with a VRS 104 in accordance with an embodiment of the present invention. The computing device 102 is in communication with an IVR/VRS system 104 over a communication channel, such as a wire or a wireless channel. For purposes of this disclosure, computing device 102 can be alternately referred to as communication device 102, implemented for example as a mobile phone, a smart phone, a tablet, or other applicable computing devices having an input/output interface, a processor, and a memory for storing and executing program code, data, and software, which may be stored on or read from computer readable media. The devices 102 may be provided with operating systems that allow execution of software applications in order to manipulate data in accordance with embodiments of the invention. Communication device 102 may be any device that can communicate with VRS 104. Personal computers, personal digital assistants (PDAs), wireless devices, smart phones, cellular telephones, internet appliances, media players, home theater systems, and media centers are some non-limiting examples of computing device 102.

The communication channel described above, which connects device 102 with a network 106 (such as a cellular network, a local area network (LAN), or the Internet, as non-limiting examples), the network 106 with VRS 104, and VRS 104 with server 108, can be a wire or a wireless communication channel between the device 102 and the VRS 104. In one embodiment, communication channel is a channel transmitting information over a network 106, such as the Internet or a local area network (LAN). In some embodiments, the communication channel includes the cellular network that connects the communication device 102, embodied as a mobile telephone, to the other channel elements and then to the VRS 104.

According to at least one embodiment, VRS 104 is a system that detects voice and keypad inputs. VRS 104 may respond with pre-recorded or dynamically generated audio to direct users on how to proceed and may be used to control functions where its interface with the user may be broken down into a series of menu choices. Specifically, each VRS can implement one or more decision trees specifying a plurality of choices that may be selected when communicating with the VRS 104. Examples of typical IVR applications include, but are not limited to, telephone banking, telephone voting, prescription refills, and credit card transactions. Companies typically use VRS to extend the business hours of operation without need to increase so much their human resources.

Throughout the present disclosure embodiments are described in which a user selects from a limited set of options, and the choice is called a “selection” that the user has “selected.” However, the inventive concept disclosed herein extends beyond only selecting from a limited set of options. In other embodiments of the invention, the user “inputs” an “input” (in contrast to merely “selecting” a “selection”), such as inputting his/her name or a message to be recorded for transmission at a later time, as non-limiting examples.

As the terminology is used in the present specification, a “computer readable medium” is a medium that stores computer data in machine readable form. By way of a non-limiting example, a computer readable medium may include computer storage media that tangibly store data. Such computer storage media may be volatile and non-volatile, removable and non-removable media implemented in any method, or technology for storage of information such as computer-readable instructions, data structures, program modules, or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices, or any other medium which may be used to tangibly store desired information and may be accessed by the computer or processor.

In one embodiment, a user provides (e.g., types in) a user request 110 to device 102 to connect to VRS 104 to perform an action. For example, user request 110 may be to connect to the VRS 104 to pay a bill or to refill a prescription. In one embodiment, the user request 110 specifies the telephone number of the VRS 104 to which to connect in order to perform the action. Device 102 may connect to the VRS 104 though a cellular network (shown as network 106 in FIG. 1) for example and/or through the Internet (also represented in FIG. 1 by network 106). Connecting through the Internet may be accomplished by creating a Voice over Internet Protocol (VOIP) telephone link to the VRS. User request 110 can then be forwarded to the VRS 104 through a network 106. VRS 104 can transmit a request for information 112 to the device 102 through the network 106. The request for information 112 may include one or more options that can be selected by the user to proceed with the call. Based on the request for information 112, another user request 110 can be initiated by selecting an option from a list of options made available to the user. As one of the options typically also includes connecting directly with the customer care professional, the user can select that option.

According to one implementation of the present embodiment, VRS 104 can also be operatively coupled to a server 108 that can store data about the user or can be coupled with a database 114 that stores information including, but not necessarily limited to, customer details, past interactions, and possible scripts. Even the decision tree defining flow of a call can be stored in the database 114.

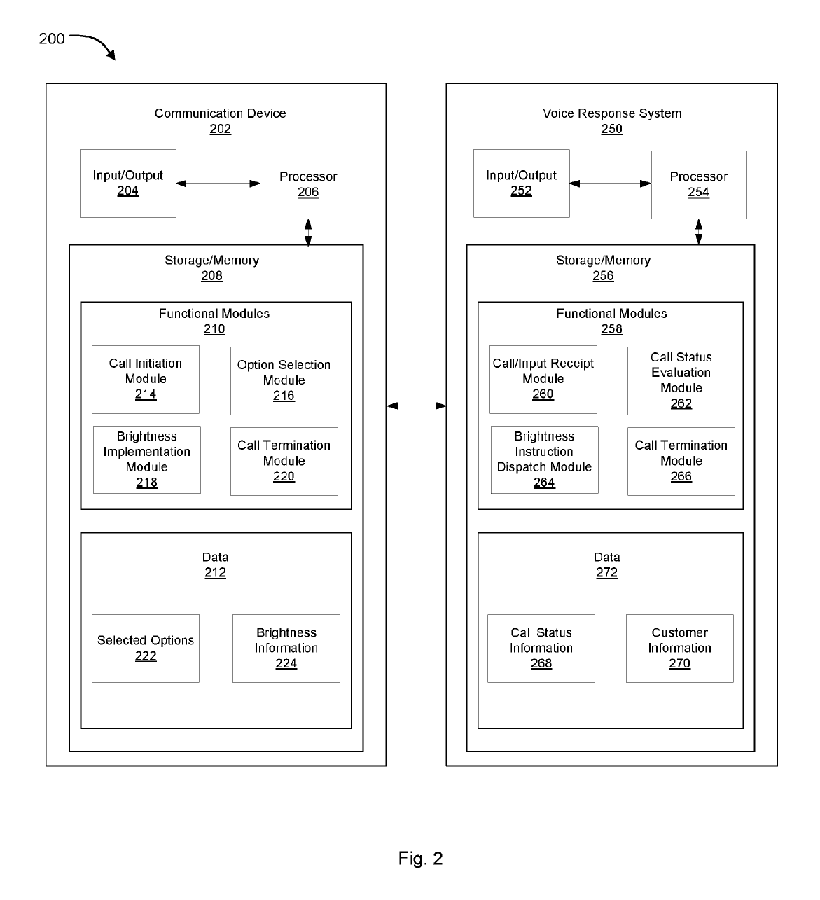

FIG. 2 illustrates exemplary functional modules of a system 200 constructed in accordance with an embodiment of the present invention. The system 200 includes a communication device 202 operatively/communicatively coupled to a voice response system (VRS) 250, for example, through a network (not shown for clarity). The device 202 includes one or more input/output interfaces 204, at least one processor 206, and a storage/memory 208 that is configured to store one or more functional modules 210 and data 212. Similarly, VRS 250 includes one or more input/output interfaces 252, at least one processor 254, and a storage/memory 256 that is configured to store one or more functional modules 258 and data 272. One skilled in the art will appreciate that any number of modules and sub-modules can be defined and/or configured within each of the device 202 and the VRS 250 or can be configured outside the devices. Such modules/sub-modules may also be configured outside these devices/systems and configured in a third party device/server to enable the functions of the present embodiment. In this embodiment, input/output interfaces 204/252, also referred to as I/O modules or I/O interfaces hereinafter, transfer communications between the device 202 and VRS 250, wherein the device 202 is operated by a user. Processors 206/254 are configured to be operatively coupled with respective I/O modules 204/252 in order to process inputs received and outputs sent/transmitted. Storage/Memory 208/256 can be configured to store data and functional modules that can be implemented through instructions that are processed by the processor.

In the present embodiment, functional modules 210 of device 202 can be configured to include or be communicatively coupled with a call initiation module 214 configured to initiate a call to the VRS/IVR 250. The initiation module 214 can initiate a call from multiple platforms such as through a tablet PC or a computer using a web-based interface or through a mobile phone/telephone. Device 202 can further include an option selection module 216 configured to enable the user to select one or more options when presented by the VRS 250 or alternatively made available in accordance with instructions stored within communication device 202. Such options can indicate choices that are made available to the user to perform the desired activities such as entering a PIN for online banking or speaking with a customer care representative. Such options can also be voice recognition enabled and therefore need not be entered on the keypad of the device 202 but instead spoken during the call. Alternative option selection and processing mechanisms are within the scope of the present invention.

Functional modules 258 of VRS 250 include a plurality of modules that are configured to efficiently communicate with communication device 202 including, but not limited to, a mobile phone, a touch-enabled phone, a smart phone, and a tablet, thereby making the communication user friendly. VRS 250 is configured to include and/or be communicatively coupled with a call/input receipt module 260 configured to receive a call and/or subsequent user inputs such as selection of options from the user/customer/consumer/individual. Such inputs may include selection of whether the matter relates to a credit card (for example, accessible through button 1) or debit card (for example, accessible through button 2), or net banking (for example, accessible through button 3). Such call may be initiated by a user through any desired communication device, such as a mobile phone or a telephone, or can be initiated automatically.

VRS 250 can further be configured to include or be communicatively coupled with a call status evaluation module 262 configured to determine and/or evaluate the status of an ongoing call. Such status may relate to, but is not limited to, situations when the user is expected to make a selection (such as when paying for a service or product by credit card), is speaking with or is waiting to speak with a customer care representative, or is listening to the options being presented by the VRS 250 for selection by the user. Such status may relate to any other situation that arises during an ongoing call between the user and the VRS. In some implementations, the call status is evaluated automatically by the VRS 250 and/or module 262 to determine the exact step/point at which the call is at a given moment/instance.

In another aspect, VRS 250 of the present disclosure can further include a brightness instruction dispatch module 264 configured to, based on the status determined by the call status evaluation module 262, dispatch and/or issue one or more brightness control instructions to the user communication device 202 such that at times when a user is expected to provide a tactile input (for example, via the keypad) to the communication device 202, the brightness of the display of the computing device may be increased, and when there is no input expected from the user/consumer, the brightness of the display may be reduced/decreased. In the present disclosure, the term “brightness” is also interchangeable the term “illumination.” Also, the extent of brightness may be controlled based on instructions from the VRS 250, that is, from the brightness instruction dispatch module 264, may be decided automatically by the communication device 202 itself, may be user defined, or may be controlled through any other suitable mechanism. For example, when the user is speaking with a customer care representative at the VRS 250, he/she does not need to view the display of the device 202 and therefore an instruction to lower the brightness of the screen of the device 202 or to darken it completely can be sent by the brightness instruction dispatch module 264, and based on the instruction the brightness of the device 202 can be lowered/minimized, unless a user setting requires otherwise. Similarly, such brightness may be lowered in cases when user is on hold and does not need to enter any option/input on the device 202. In some implementations, conditions during which the brightness needs to be lowered may be customized by the user and/or the VRS itself or can be combined. Brightness can be increased when user input is required for selecting an option or when viewing content/data available on the device 202. Similarly, when the VRS 250 sends instruction to the device 202 to notify the caller that the VRS 250 will record the message/interaction from the caller, the VRS may also send an instruction to darken the touch screen if the VRS detects that the device 202 is being used to provide the message (assuming the message is audio message and not visual/textual). In some implementations, the VRS 250 sends a notification to the device 202 that illumination of the touch screen of the device 202 is not needed. When the device 202 receives the notification from the VRS 250, the device 202 may darken or dim partially the touch screen based on default or user-specified settings.

For processing at the device 202 end, functional modules 210 include in this example a brightness implementation module 218 configured to receive instructions from the brightness instruction dispatch module 264 of the VRS 250, and reduce/increase/change the brightness of the display of the device in accordance with the instruction.

In accordance with an alternate embodiment, instead of sending explicit brightness control instructions, the VRS 250 is configured to send the status of the call (such as on hold, user input required, and options being presented) to the device 202, and the brightness implementation module 218 of the device 202 accordingly processes the call status received from the VRS to determine whether to reduce/increase/maintain the brightness and magnitude of the display of the device 202.

According to another embodiment, the device 202 and the VRS 250 further include call termination modules 220 and 266 respectively, wherein the termination modules can be configured to terminate the call at any desired instance, thereby disconnecting the call between the customer/caller/user 202 and the VRS 250. (In other embodiments, calls are terminated by other mechanism.)

Some embodiment are configured such that the data 212 of the device 202 and the data 272 of the VRS 250 includes one or more of customer information 270, brightness information 224, preferences, settings, selected option recorded information 222, call status information 268, among other like content.

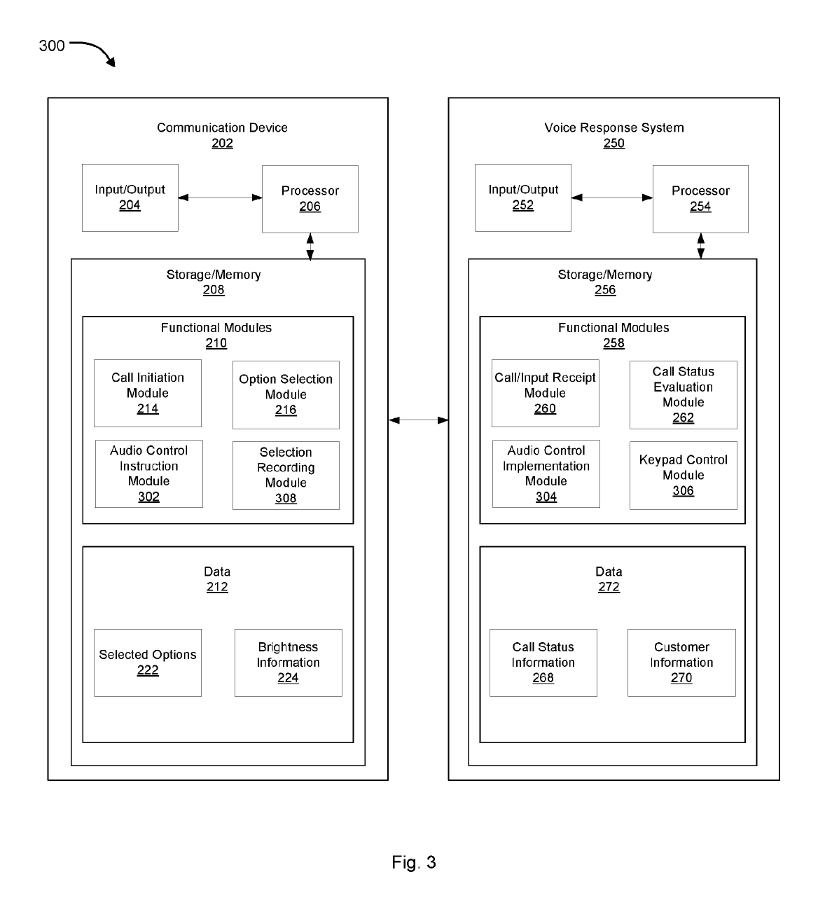

FIG. 3 illustrates an embodiment, system 300, with additional exemplary functional modules. As shown, modules such as a call initiation module 214 and an option selection module 216 can be integrated into the communication device 202 of FIG. 2. For example, the communication device 202 of this embodiment may be implemented as a mobile phone.

In view of the preference of some users not to hear audio content while on hold, the embodiment of FIG. 3 may be further configured such that the communication device 202 includes an audio control instruction module 302 configured to issue an instruction to cease playing the audio/music/broadcasted programming/pre-recorded messages while the VRS 250 has put the user on hold or is otherwise waiting for a VRS response. Such audio may ordinarily be heard when the VRS is connecting the user with a customer care representative. As such audio can be annoying and disturbing for users, audio control instruction module 302 can enable the user to issue an instruction to cease playing of the audio through a predefined keypad input or a new input that is configured on the keypad/touch-screen, enabling the instruction to be either processed through the processor 206 of the device 202, silencing the audio at the communication device end itself, or may be processed at the VRS 250 to stop the audio from being played at the VRS end.

In some embodiments, the VRS 250 may include an audio control implementation module 304 configured to receive an instruction from the user's communication device 202 (originating from module 302) to cease playing the audio content (such as recorded advertisements, product information, music, broadcasted programming, or pre-recorded messages, that is transmitted while the user is waiting or while the caller is on hold) being transmitted to the device 202 based on instructions received from the user/communication device 202. Therefore, the VRS 250 itself stops sending the audio content to the device 202.

In other embodiments, once the audio or call hold/waiting status is complete, a notification is sent to the device 202 to enable the user to take action, to leave a message, or to speak with the customer care representative. After such notification is received, either by device 202 or VRS 250 or both, the audio that was ceased earlier can be restored for efficient communication between the customer and the VRS.

According to another embodiment, the VRS 250 of the present disclosure further includes a keypad control module 306 configured to, based on the status determined by the call status evaluation module 264 of FIG. 2, issue instructions for controlling/activating/de-activating the keypad of the user communication device 202, such as a text-input keypad (touch-based or physical) of a mobile phone. Such instructions received from the VRS 250 can then be processed by the processor of the device 202 to de-activate/activate the keypad. The keypad may be deactivated when not required for input from the user and then may be re-activated when user input is required. Similarly, any other feature of the handset/communication device may also be deactivated/activated/controlled by the VRS by the functional modules 210 of the communication device 300. Any other such control of features/characteristics of the communication device 202 is within the scope of the present embodiment.

In yet another embodiment, communication device 202 of the proposed system can further include or be operatively/communicatively coupled with an input recording module 308 configured to record options/selections, that is, “inputs,” being entered/chosen by a user during an ongoing call with the VRS 250 and use/store such recorded options/selections for future retrieval and issuance to the VRS 250, thereby enabling faster and intelligent call processing with the VRS 250 during a future session. During the future session, the inputs from the prior session may be presented to the user. The form of the presentation may be a textual list, as a non-limiting example. The recorded options/selections may also be stored in the storage 256 of the VRS 250.

In another implementation, the input recording module 308 or any component/sub-module thereof may be implemented as a downloadable and installable application that is installed in a mobile/smart phone 202 to enable the recording of the selected options by a caller while communicating with VRS 250. In order to enable such an operation, a record key (not shown) may be provided on the interface of the application or any other part of the display to enable recording of all or a defined set of inputs selected by a caller. In operation, when communication is established between a caller and a VRS 250, while the application operates in the background, a notification may be sent to the caller asking him/her whether he/she wishes to select an option offered by the VRS 250 and whether he/she would like to record the selection of the option and subsequent options. In alternate implementations, it may be recorded also that a selection menu is presented.

Embodiments of the mobile/smart phone 202 may be implemented such that the input recording module 308 records the sequence of selections made by the user in order to replay the recorded sequence later when the user desires. Accordingly, the input recording module 308 is configured with the ability to determine when portions of a user's input correspond to a single selection or are associated with separate selections, for example, to determine that a user's input of “2” and then “3” represent a single selection “23” or two separate selections “2” and then “3.” To enable the input recording module 308 to make this determination, the VRS 250 sends to the mobile/smart phone 202 a signal (such as “new_selection_signal”) that indicates whenever the text it plays to the user requires him/her to enter a selection.

While the mobile/smart phone 202 is in learn mode (that is, it is learning what the user inputs), the input recording module 308 records the signal “new_selection_signal” (or equivalent) from the VRS 250 as the beginning of a new selection. Then, the input recording module 308 records all the input the user enters until another new_selection_signal is sent by the VRS 250 or an end_selection_signal (signifying that the VRS 250 no longer needs user input at that time in the call) is sent by the VRS 250 or a stop_learning key (for the user to indicate that he/she no longer desires to record input) is pressed by the user. (Embodiments may be implemented such that the user input is spoken input and/or keyboard input.) When the mobile/smart phone 202 receives the next new_selection_signal,—the input recording module 308 records it as a separator and then starts again to record user input until another new_selection_signal or an end_selection_signal is received from the VRS or a stop_learning key is pressed by the user. When an end_selection_signal arrives or a stop_learning key is pressed, the input recording module 308 stops recording input and exits the learn mode. To use the recorded selections in a future call, the mobile/smart phone 202 enters a “play mode.” While in a play mode, whenever a new_selection_signal is received from the VRS 250, the mobile/smart phone 202 sends to the VRS 250 the user input that it recorded from the user during the learn mode for each specific selection, that is, the input it received until the next new_selection_signal or until the end_selection_signal or stop_learning key.

The caller may also choose not to record the selection of options. However, if the caller wishes to record the selections, the record key can be pressed/selected. The next time the user calls the VRS for the same purpose as he/she called the last time, the user has the option to choose to move to the last step right away based on the recorded inputs that the user provided in a previous session. If the user has called the same VRS as a previous time but for a different purpose, the inputs that had been stored during the previous call may be displayed on the user's phone screen. The user may select what to input quickly without needing to listen to all of the VRS instructions.

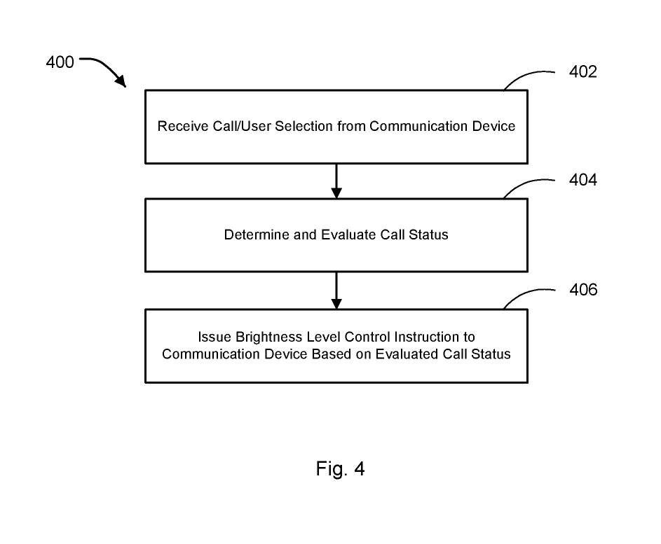

FIG. 4 provides a flowchart 400 illustrating an exemplary method of implementing instructions received from a VRS in accordance with an embodiment of the present invention. At step 402, the VRS receives a call and/or user input from a communication device. At step 404, the VRS determines the call status to identify which particular call activity is taking place. Such call status can be evaluated either periodically, or continuously, or in real-time. At step 406, based on the determined call status, VRS can issue instructions for changing the brightness level of the display of the communication device and/or activating/de-activating the keypad of the communication device. Such instructions can then be processed at the communication device by means of software, or hardware, or firmware, or any combination thereof.

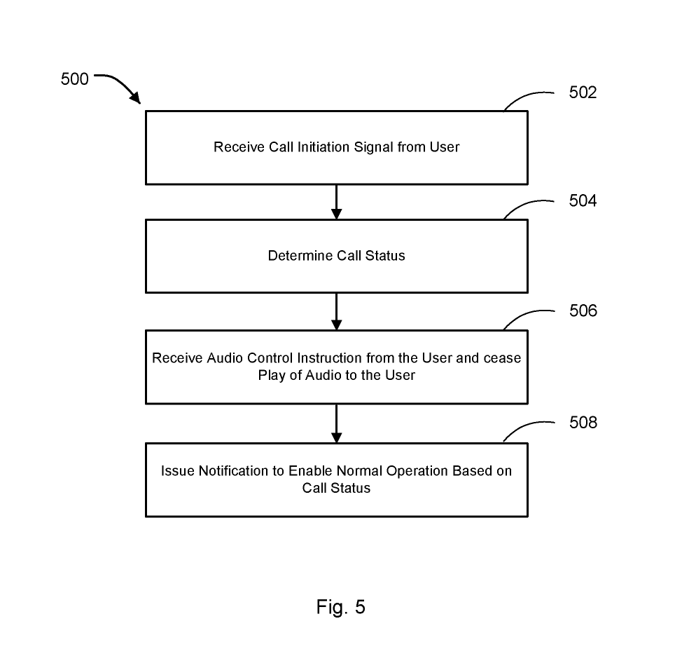

FIG. 5 provides a flowchart 500 illustrating an exemplary method of implementing instructions received from a user in accordance with an embodiment of the present invention. At step 502, a communication device such as a mobile phone receives a call initiation signal from a user. At step 504, the communication device determines the status of the call by assessing each activity taking place during the call. At step 506, if the user is listening to audio/music or a pre-recorded message that he/she does not wish to hear while the call is in place/on-hold, the communication device receives an input from the user, and based thereon the audio is set so that it is not audible to the user. Such configuration can either be done at the communication device itself by muting the device or can be done by sending an instruction to the VRS to discontinue/disable to the audio. At 508, the communication device evaluates status of the call and either issues a notification to the VRS or receives instead the notification to enable normal operation of the communication device, enabling the user to speak with or continue interaction with the VRS.

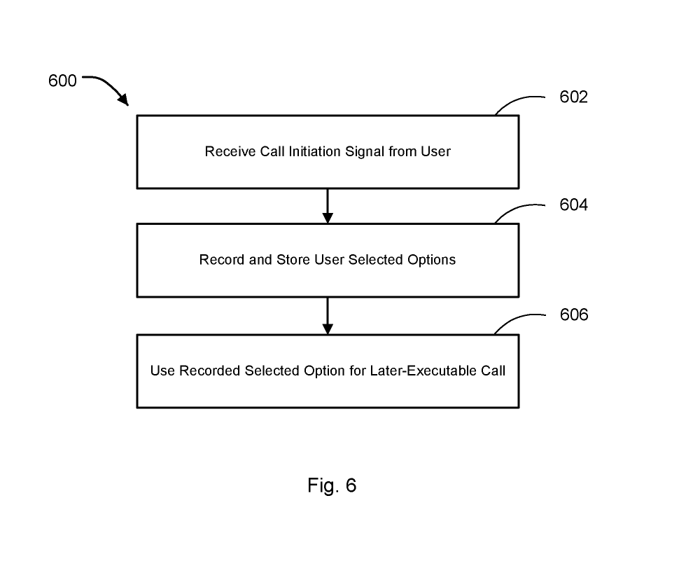

FIG. 6 provides a flowchart 600 illustrates an exemplary method of recording user inputs into a communication device in accordance with an embodiment of the present invention. At 602, the communication device receives a call initiation signal from a user. At 604, upon initiation of a call, the communication device records each option selected as the input from the user at the VRS and stores the inputs for one or more future calls. At 606, the communication device uses the recorded inputs in a later-executed call made by the user to the VRS.

In some embodiments of the invention, instructions sent from the VRS can be characterized as “suggestions” instead of as “commands” From example, the VRS logic may determine that screen illumination at the communication device is no longer needed, but the communication device logic may take priority and determine to maintain screen illumination, either in view of internal circumstances within the communication device or in view of a user request to the communication device.

In some embodiments of the invention, the communications device is configured to enable a user to respond as follows to being placed on hold: upon user request, the communication device sends, and resends periodically, a recorded message, such as “Please press ‘3’ if you are a live person listening to this.” Until a service representative associated with the VRS responds (such as by pressing “3” to indicate his/her presence), the speakerphone is muted. When a service representative indicates his/her presence, the speakerphone is unmuted and the user may begin the conversation with the service representative. Embodiments of the invention may be implemented so that an application residing on the communication device is configured in advance to respond as a user desires to the VRS (or to a human operator, such as a service representative, at the side of VRS communicating with the user) placing the user on hold. During configuration, the application prompts the user, for example by displaying words on the screen or by providing audio instructions via a speaker, for a personalized message that the application will repeatedly send to the VRS (or human operator) for the service representative to hear when the hold state has concluded. A non-limiting example message is “I have muted my telephone. Please press ‘1’ to indicate your presence.” The application also prompts the user for the hold termination code that the service representative is to send. (In the preceding example, the hold termination code is “1.”) Variations of this implementation may enable the user to configure the application to respond differently for different VRSs according to a selection the user makes during the conversation. (A non-limiting example of the advantages the option to configure different responses is that responses in different languages may be configured.)

In other embodiments, an application may be implemented to be configured in advance to respond to a VRS anticipated to regularly prompt the caller to enter a value (such as prompting the caller to “press ‘1’”) to indicate that the caller wishes to remain on hold. The application configured accordingly will repeatedly enter the value for the VRS to receive regardless of whether it has recently prompted the caller for the value. The application may also be configured to repeatedly send a message indicating that the telephone has been muted and that the service representative must enter a specified value to alert the caller that the hold state has concluded. When the application receives the requested value from the service representative associated with the VRS, the communication device is unmuted. Optionally, the application plays a ringtone and waits for the user to press a designated key as an analog to answering a new call. After the user presses the key, the application unmutes the audio from the side of the service representative.

As an alternative to or an addition to configuring the application in advance of a call, an application may be implemented to display options on the touch screen that a user may select while he/she is already placed on hold. A special button may be displayed such that, when pressed during a hold state, prompts the user for (1) the value that the user must send to indicate that he/she wishes to remain on hold, (2) the message to repeatedly send to the VRS, and (3) the value that the service representative must press that indicates the conclusion of the hold state and causes the application to unmute the communication device. A similar configuration can be available for situations in which the VRS does not repeatedly prompt the user to enter a value to indicate that he/she wants to remain on hold. For this option, the application merely needs to prompt the user for (1) the message to repeatedly send to the VRS and (2) the value that the service representative must press for the application to unmute the communication device.

As somewhat of a hybrid of the above embodiments, the application of another embodiment residing on the communications device has some settings specified in advance, such as during system preconfiguration, and some settings specified while in a hold state during a call. Specifically, the message to repeatedly send to the VRS and the value that the service representative must press for the application to unmute the communication device are preconfigured. The value that the user must send to indicate that he/she wishes to remain on hold is set during the call.

In some embodiments of the invention, a communication device is configured to discern temporal aspects of the operation of the VRS, for example, whether an outgoing message or instruction has begun or ended, by sound/speech analysis or artificial intelligence, and in alternate embodiments the communication device and the VRS are configured exchange special signal to improve the reaction of the communication device to the state (temporal aspect) of the VRS operation. That is, for the example in which VRS is in the state of providing an outgoing message to the communication device, the VRS may be configured to send a special signal (such as an audio signal, as a non-limiting example) to the communication device to indicate that the message has begun and another signal to indicate that the message had ended. One use for such signals is to indicate to the communication device to display the numeric keypad and/or not to darken its screen (or to illuminate a screen, if it is not already illuminated). When a VRS is not configured to send special signals, artificial intelligence within the communication device may detect receipt of a VRS announcement by recognition of particular recorded speech and may detect the end of the instruction by hearing a ring signal to alert the user that the announcement has ended and a human representative may soon be available. Similarly, the VRS can be configured to send a special signal indicating that recorded music is about to begin or to end, or the communication device can be configured to discern these states by using artificial intelligence.

The communication device may also be configured in various ways to respond to a break in communication with the VRS. For example, after noting that the VRS has begun sending recorded music, a long silence with no other message or signal can be interpreted as an indication that the VRS has become disconnected with the communication device. Such feature is useful when the communication device has muted the music, and the user would not otherwise know that the call has ended. However, in recognition that, in states in which silence from the VRS is intentional, logic may be added to check for an occasional announcement or other indication (such as a “heart beat” tone sent every five seconds) from the VRS that the call is still in progress.

The communication device may be configured so that the user indicates, for example, in the device's contact list, that a VRS is associated with a particular dialed number, so the communication device will be prepared to monitor for special states.

Embodiments of the invention may be implemented in the form of software, firmware, or hardware, or any combination thereof. For an embodiment implemented as software, the system may be installed/downloaded onto any applicable communication device to enable the device to receive instructions from the VRS and to implement the disclosed functionality on the device, such as lowering/increasing brightness and activating/deactivating the keypad. Although the present disclosure has been explained with respect to a defined number of examples, such as audio, brightness, and keypad control, any other instruction that can be issued by the VRS to control the functioning/performance/behavior of the device is also within the scope of the present invention.

As used herein, and unless context dictates otherwise, the terminology “coupled to” is intended to include both direct coupling (in which two elements that are coupled to each other contact each other) and indirect coupling (in which at least one additional element is located between the two elements but not preventing their mutual communication). The terms “coupled to” and “coupled with” are used synonymously. Within the context of this disclosure, the terminology “coupled to” and “coupled with” are also used euphemistically to mean “communicatively coupled with” over a network, where two or more devices are able to exchange data with each other over the network, possibly via one or more intermediary device

It should be apparent to those skilled in the art that many more modifications besides those already described are possible without departing from the spirit and scope of the invention. The inventive subject matter, therefore, is not to be restricted except in the spirit of the appended claims.

1-34. (canceled)

35. A method for a smart phone conducting a voice call with a second party, the method comprising:
receiving audio signals transmitted from the second party;
performing a pre-specified set of actions in accordance with the received audio signals.

36. The method of claim 35 further comprising enabling a user of the smart phone to perform at least one action selected from the group consisting of:
a. muting the smart phone to prevent the playing of audio transmitted by the second party;
b. unmuting the smart phone to allow the playing of audio transmitted by the second party;
c. initiating a periodic transmission of a recorded message to the second party;
d. terminating the periodic transmission of the recorded message to the second party;
e. initiating a periodic transmission of a user-specified audio signal to the second party;
f. terminating the periodic transmission of the user-specified audio signal to the second party;
g. initiating a learn mode to record both signals from the second party and resulting user input;
h. terminating the learn mode;
i. initiating a play mode to use the signals and the user inputs recorded during the learn mode in a call;
j. terminating the play mode; and
k. specifying the audio signals that the receipt thereof causes the performing of the pre-specified set of actions.

37. The method of claim 35, wherein the pre-specified set of actions is selected from the group consisting of:
a. playing a ringtone;
b. illuminating the display of the smart phone;
c. displaying a keypad on the smart phone;
d. recording input entered by a user of the smart phone; and
e. transmitting to the second party user input recorded during a prior call;
f. terminating a periodic transmission of a recorded message to the second party;
g. terminating a periodic transmission of a user-specified audio signal to the second party;
h. unmuting the smart phone to allow the playing of audio transmitted by the second party.

38. The method of claim 35, wherein the second party transmits the audio signals using a second phone.

39. The method of claim 35, wherein the second party transmits the audio signals using a voice response system.

40. A smart phone for conducting a voice call with a second party, the smart phone comprising:
a touch screen;
an input/output module operative to transfer communications to and from the smart phone and the second party;
a processor operatively connected to the input/output module to receive input from a user of the smart phone and from the second party and to send output to the user and to the second party; and
storage containing instructions that, when executed, cause the processor to enable the smart phone, before the user calls the second party, to receive audio signals transmitted from the second party and to perform a pre-specified set of actions in accordance with the received audio signals.

41. The smart phone of claim 40, wherein the user is enabled to perform at least one action selected from the group consisting of:
a. muting the smart phone to prevent the playing of audio transmitted by the second party;
b. unmuting the smart phone to allow the playing of audio transmitted by the second party;
c. initiating a periodic transmission of a recorded message to the second party;
d. terminating the periodic transmission of the recorded message to the second party;
e. initiating a periodic transmission of a user-specified audio signal to the second party;
f. terminating the periodic transmission of the user-specified audio signal to the second party;
g. initiating a learn mode to record both signals from the second party and resulting user input;
h. terminating the learn mode;
i. initiating a play mode to use the signals and the user inputs recorded during the learn mode in a call;
j. terminating the play mode; and
k. specifying the audio signals that the receipt thereof causes the performing of the pre-specified set of actions.

42. The smart phone of claim 40, wherein the pre-specified set of actions is selected from the group consisting of:
a. playing a ringtone;
b. illuminating the display of the smart phone;
c. displaying a keypad on the smart phone;
d. recording input entered by a user of the smart phone; and
e. transmitting to the second party user input recorded during a prior call;
f. terminating a periodic transmission of a recorded message to the second party;
g. terminating a periodic transmission of a user-specified audio signal to the second party;
h. unmuting the smart phone to allow the playing of audio transmitted by the second party.

43. The smart phone of claim 40, wherein the second party transmits the audio signals using a second phone.

44. The smart phone of claim 40, wherein the second party transmits the audio signals using a voice response system.
